(19) United States
(12) Patent Application Publication
(10) Pub. No.: US 2018/0163755 A1
(43) Pub. Date: Jun. 14, 2018

(54) Holder With Liner For A Rod

(71) Applicant: Pit Bull Products, Inc., Huntsville, AL (US)

(72) Inventor: Charles VanValkenburgh, Hunstsville, AL (US)

(73) Assignee: Pit Bull Products, Inc., Huntsville, AL (US)

(21) Appl. No.: 15/882,125

(22) Filed: Jan. 29, 2018

Related U.S. Application Data
(63) Continuation of application No. 14/589,704, filed on Jan. 5, 2015, now abandoned.

(51) Int. Cl. F16B 2/22; F16B 2/00

(52) U.S. Cl. CPC F16B 2/22; F16B 2/005

(57) ABSTRACT

A hanger having a base that curves into a single arm that forms a U-shaped channel. A single liner fitted within the channel designed to engage and secure onto a rod. A pair of tubes extending downwardly at an angle from a centered section and the base of the frame extends downwardly into a pair of legs that secured into the centered section of a pair of tubes.

### CROSS-REFERENCE TO RELATED APPLICATIONS

The present application is a continuation application of U.S. application Ser. No. 14/589,104 filed Jan. 5, 2015.

### BACKGROUND OF THE INVENTION

The present invention relates generally to a grip liner which can be used in connection with a plated or painted pipe, tube, conduit, rod, shaft, or any other generally shaped object (generally referred to herein as a rod) to help prevent the plating or paint from scratching or pealing.

There are a variety of rods used in every industry and often these are plated, painted, or coated either for design or functional purposes. When attaching to the rod such as a clamp or other type of vice, the plaiting or paint can become scratched or chipped. This leaves an unsightly rod when the clamp or vice is separated therefrom. In addition, if coated for a particular purpose the removal of the coating could cause issues or structural problems.

The present invention is directed to allow a rod to be secured to a secondary object through a liner invented as described and shown.

### BRIEF SUMMARY OF THE INVENTION

The present invention includes in one embodiment an apparatus for engaging a rod is defined to include a frame, at least one arm extending from the frame and a liner fitted within each arm. The frame is configured to be secured to a surface. The at least one arm includes a U-shaped channel having legs curved into a base of the channel, and further includes an overhang lip extending over each leg. The liner includes a U-shaped profile defined to have a pair of legs extending into a base of the liner, and further includes an outside edge of the liner is grooved to define a pair of opposing flanges extending from the liner and configured to frictionally engage the U-shaped channel. Wherein when the liner is installed in the channel the overhang lips extending over the legs of the liner.

In another aspect the legs of the U-shaped channel extend at about a 15° angle, while the legs of the U-shaped liner extend at about a 10° angle. In another aspect, the frame has ends distal from each other and the at least one arm comprising at least a pair of arms separately extending from the ends of the frame.

In another embodiment of the invention there is provided a holder for engaging a rod defined to include at least one arm having a U-shaped channel, the U-shaped channel configured to have legs curved into a base of the channel; and further including a liner fitted within each U-shaped channel, each liner includes: a U-shaped profile defined to have a pair of legs extending into a base of the liner, and further includes an outside edge of the liner is grooved to define a pair of opposing flanges extending from the liner and configured to frictionally engage the U-shaped channel.

### BRIEF DESCRIPTION OF THE DRAWINGS

A fuller understanding of the foregoing may be had by reference to the accompanying drawings, wherein:

FIG. 1 illustrates a holder with a liner for use with a pipe or conduit in accordance with an embodiment of the invention;

FIG. 2 illustrates in an exploded view the holder with liner from FIG. 1 in accordance with an embodiment of the invention;

FIGS. 3A, 3B, and 3C illustrate in various views the holder with liner from FIG. 1 and illustrating the pipe positioned in the holder in accordance with an embodiment of the invention;

FIG. 4 illustrates as a cross sectional view the holder with liner from FIG. 1 in accordance with an embodiment of the invention;

FIG. 5 illustrates another embodiment of the invention showing an arm with a liner;

FIG. 6 illustrates another embodiment of the invention showing an arm secured to a wall or surface;

FIG. 7 illustrates another embodiment of the invention showing an arm secured to a floor or surface; and

FIG. 8 illustrates another embodiment of the invention showing an arm secured to a hanger.

### DETAILED DESCRIPTION OF THE INVENTION

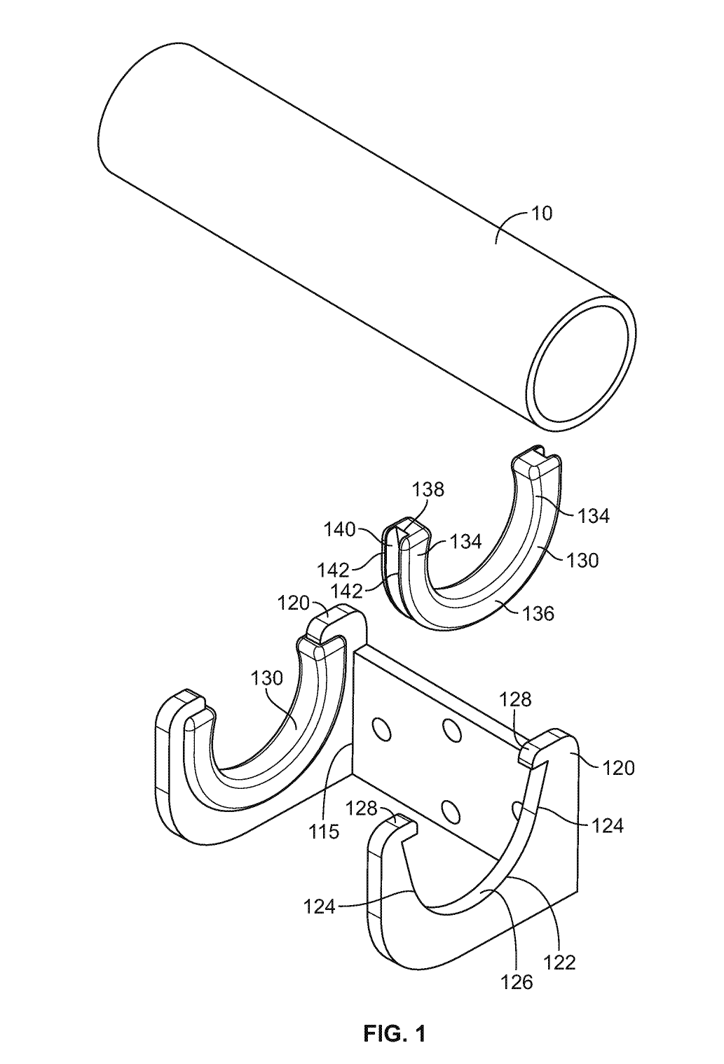

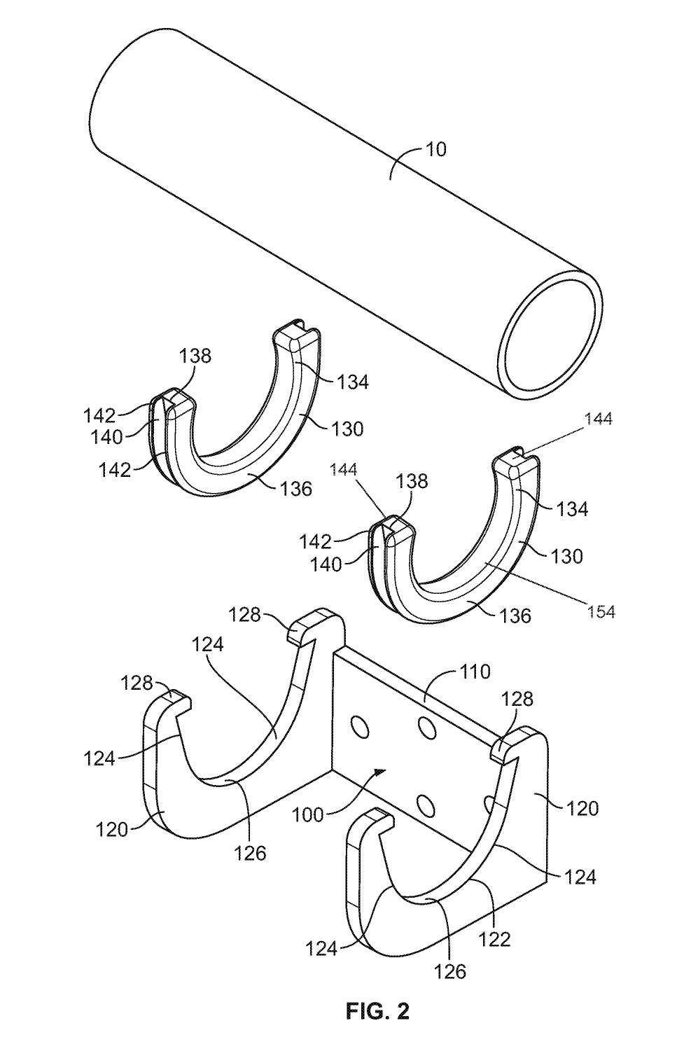

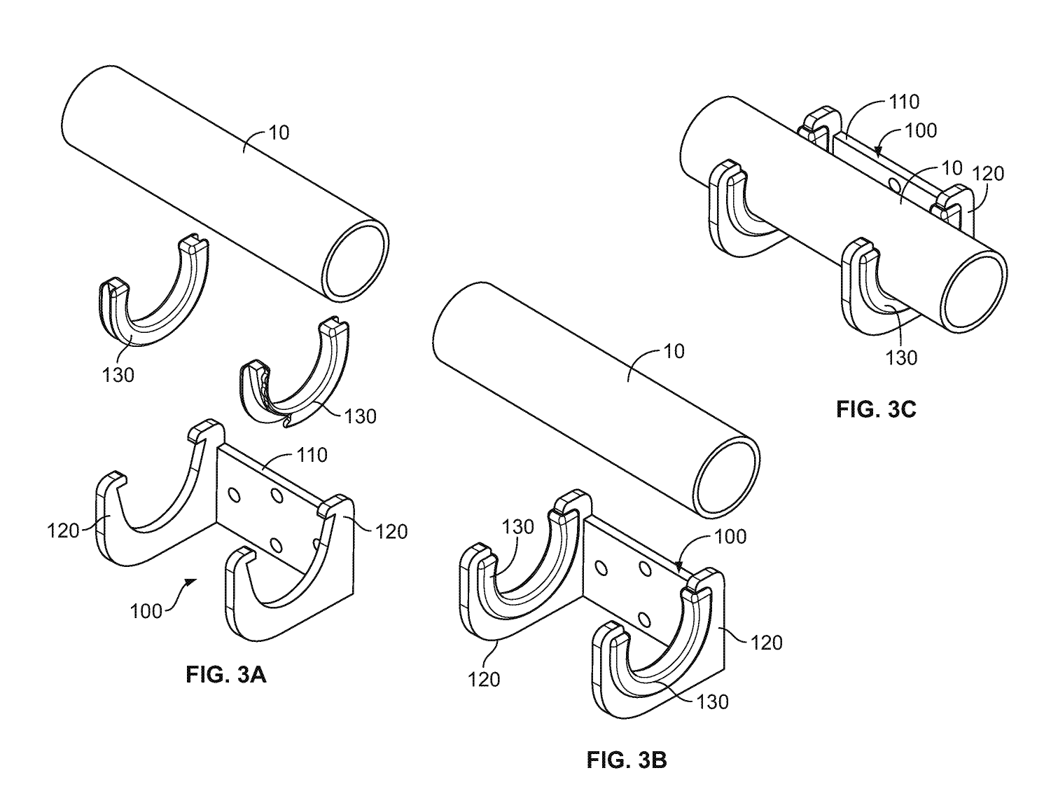

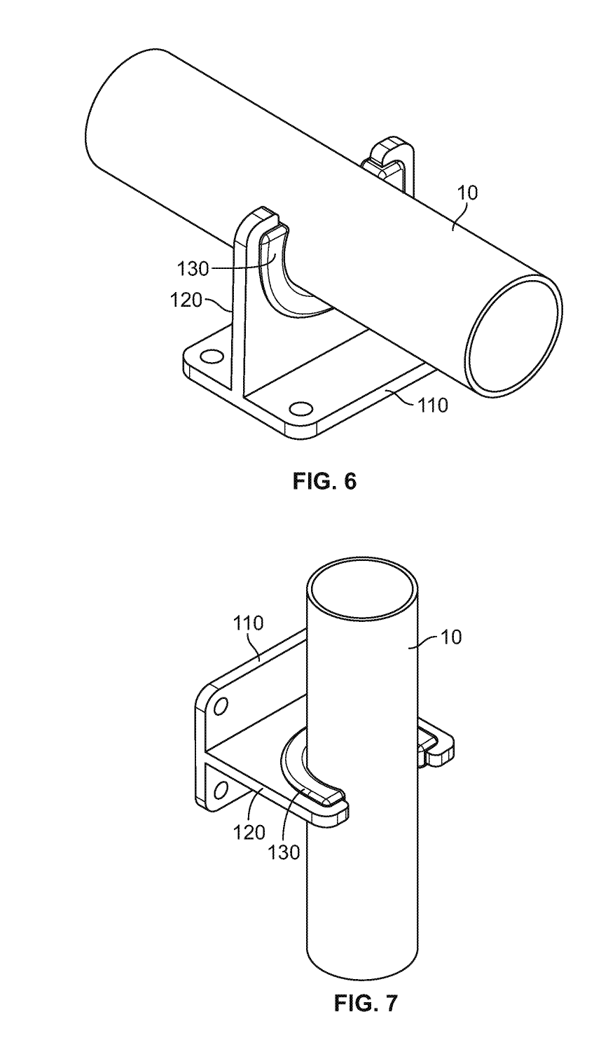

Referring now to FIGS. 1-8, a holder 100 is illustrated for receiving, holding and generally engaging a pipe, tube, conduit, rod, shaft, or any other generally shaped object (generally referred in the description and claims as a rod 10). The holder 100 includes a frame 110 that can be secured to a surface. The frame 110 includes ends 115 distal from each other. Extending from the frame is one or more arms 120. As illustrated, each end of the frame 110 may include an arm, however, it is within the scope of the invention to simply provide a single arm or even a plurality of arms extending along the base or certain spaced intervals from each other. Each arm 120 includes a U-shaped channel 122 that has the legs 124 extending into the base 126 of the channel. In one aspect, the legs 124 may taper or angle into the base 126 at or around a 15° angle. In another aspect, the, the legs 124 may include an overhang lip 128 extending at the beginning of the legs 124.

Fitted within each U shaped channel 122 is a liner 130. The liner has a U-shaped profile to correspond to the channel 122. The liner thus includes a pair of legs 134 that extend into the base 136 of the liner. The outside edge 138 of the liner 122 is grooved 140 to create a pair of opposing flanges 142 extending from the liner and defined to frictionally engage the U-shaped channel 122 when installed. When installed the overhang lips 128 rest on top of the liner top edges 144. In addition, the legs 134 of the liner may be tapered at or around a 10° angle. Creating a difference in angle between the liner and the channel may help create a more defined grip onto a pipe or conduit when positioned in the liner.

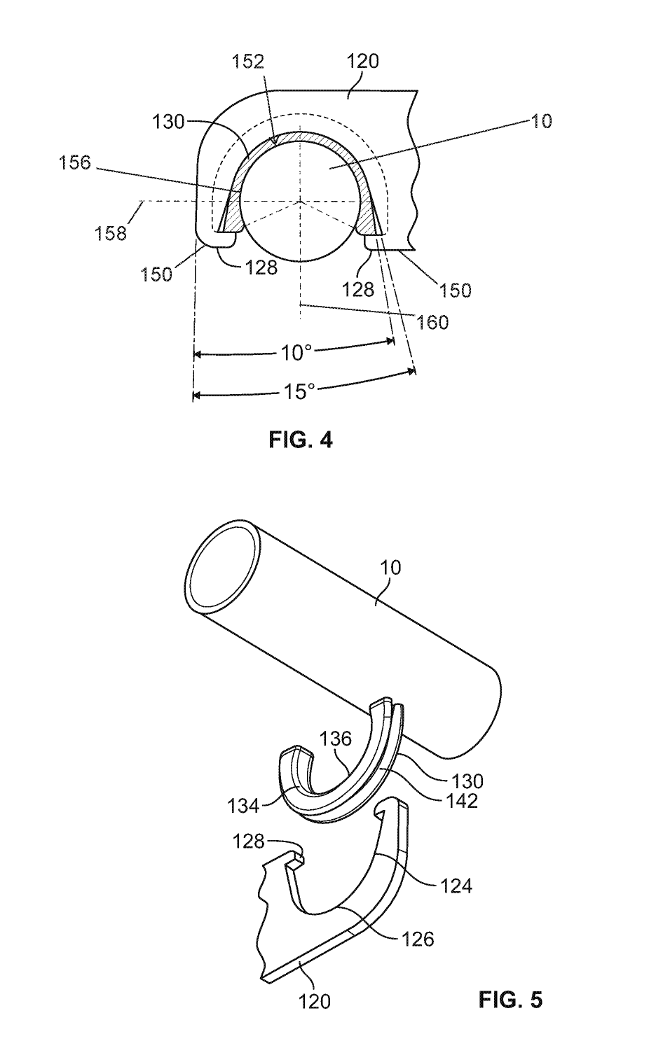

Continuing to refer to the figures and especially FIG. 4, each arm 120 includes a U-shaped channel 122 formed by having a pair of opposing legs 124 curved into a base 126 of the arm 120. Each leg 124 further includes a free terminal edge 150. Each free terminal edge extending towards each other over a portion of an opening 152 defined by the U-shaped channel 122 between each leg 124 to further define a lip 128. In addition, the free terminal edge 150 of each leg 124 is configured to be contactless. A single liner 130 is fitted within each U-shaped channel 122. The single liner 130 includes a U-shaped profile formed by having a pair of curved members 134 with terminal ends 144 extending towards a base 136 of the single liner. The single liner further includes an outside surface 138 grooved 140 to define a pair of opposing flanges 142 extending from the one terminal end to the other terminal end of the single liner and configured to frictionally engage entirely onto the U-shaped channel 122. When the single liner is installed in the U-shaped channel the lips 128 from each leg 124 extends over the terminal ends 144 of the liner 130 such that a portion of the liner does not extend past the lip of the terminal edges of the U-shaped channel. In addition, the single liner 130 is configured to include an inside surface profile 154 defined to have a shape of a circular major arc 156 to engage a rod 10 (as shown by the intersecting horizontal and vertical centerlines 158, 160 respectively).

In addition to the above, the invention may include providing an arm 120 with a liner 130 as an extension to any product that will secure onto a rod. This may include being able to secure the arm to a floor or wall or even in use with a clothes hanger. When attached to a wall the liner would secure a vertical rod such as a broom or shovel handle or when the liner is secured to the floor a sprinkler pool or other items can be secured.

In one embodiment the liner may be made of a plastic while the holder may be a metal or plastic base. Having a plastic holder would help allow slight deflection when the rod is inserted or removed while also allowing movement without the scratching or pealing of the paint, plating, or coating on the rod.

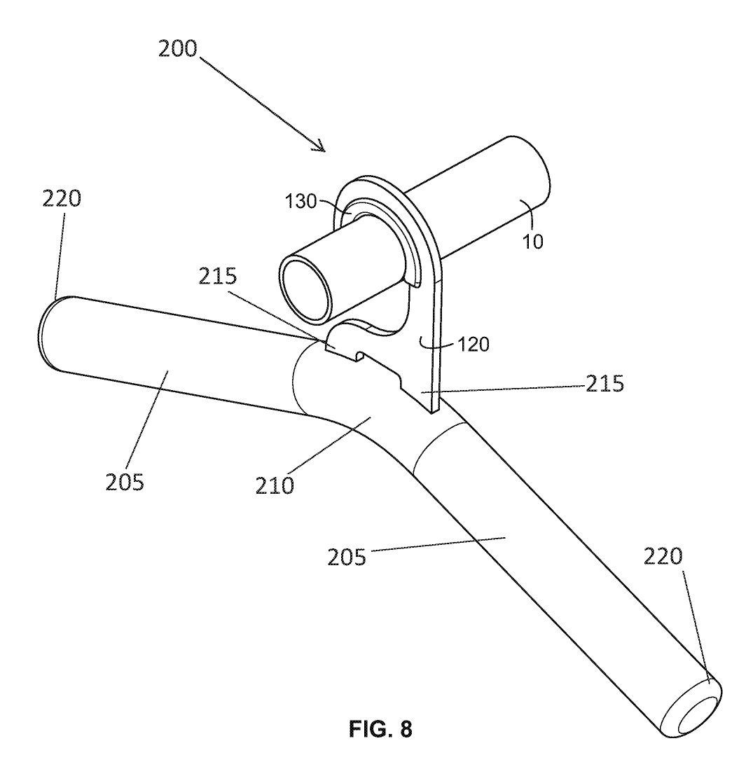

Referring to FIG. 8, a hanger 200 is illustrated for heavy garments or items such as tactical gear, racing gear, diving gear, suits, fire suits, or jackets. The configuration of the hanger 200 shown in FIG. 8 resembles a conventional coat hanger but has heavy tubes 205 angled downward from an arm 120 (configured as illustrated and described herein with reference FIG. 4) onto which the shoulder portions of the garment would rest. The arm 120 is secured to a center base 210 of the hanger 200 by having the arm branch into a pair of legs 215 that separately both attached to the center base 210. End caps 220 on the downward angled tubes serve to add friction to aid in preventing the garment from sliding off.

The hanger presented is a basic form. It can also be configured in numerous shapes to accommodate various different types and sizes of garments or gear. It can also be augmented with appendages such as rods, hooks or fasteners to hold additional or secondary items such as helmets, gloves, goggles, boots, weapons, ammunition or protective devices.

A key element of the new invention is a plastic liner 130 that is semi-circular with an opening on one end and fixed to the hanger 200 such that it acts as a passive spring to engage a tube or bar 10 of the correct diameter, referred to as a hanger mount, by snapping into place. Once the liner 130 is snapped into place the hanger can only be removed if a reasonable amount of force is applied to disengage the liner from the hanger mount. This is useful when the hanger mount is attached inside a moving vehicle such as a car, truck, van, trailer, water vessel or aircraft since it will help to prevent the hanger and hung item from falling from its position.

The hanger mount that consists of a cylindrical tube or pipe is the correct size to allow the liner to snap into place as a passive lock. One variation of the hanger mount can be mounted perpendicular to a wall or surface. Another variation can consist of a correctly sized rod mounted parallel to a wall or surface as a clothing rod would mount in a closet. In either case the length of the hanger mount and thickness of hanger/gear determines how many hangers can be hung per location. In addition to providing a passive lock, the liner 130 is constructed of a non-metallic material that reduces scuffing or scratching of the bar or hanger mount to which it is attached. The diameter of the opening of the liner is generally large enough that it will easily hang on a closet rod without snapping into place. The passive locking ability is generally not required inside a non-moving building or house since gravity will adequately keep the hanger in place.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. An holder for engaging a rod comprising:
a frame having laterally extending base that curves into a single arm, the single arm extending from the base to form a U-shaped channel, the arm extending into a free terminal edge;
a single liner fitted within the U-shaped channel, each single liner includes: a U-shaped profile formed by having a pair of curved members with first and second terminal ends, and further includes an outside surface of the single liner, wherein the entire outside surface of the single liner is grooved to define a pair of opposing flanges extending from the first terminal end to the second terminal end and configured to frictionally engage entirely onto the U-shaped channel, and wherein when the single liner is installed in the U-shaped channel, the lips defined by the free terminal edge of the arm over the first terminal ends of the single liner such that a portion of the single liner does not extend past the lip of the terminal edge of the U-shaped channel, and wherein the single liner is configured to include an inside surface profile defined to have a shape of a circular major arc to engage a rod;
a pair of tubes extending downwardly at an angle from a centered section; and
wherein the base of the frame extends downwardly into a pair of legs that secured into the centered section of a pair of tubes.
